(19) United States
(12) Patent Application Publication
(10) Pub. No.: US 2008/0057311 A1
(43) Pub. Date: Mar. 6, 2008

(54) Surface-treated lead chalcogenide nanocrystal quantum dots

(76) Inventors: Jennifer A. Hollingsworth, Los Alamos, NM (US); Jeffrey M. Pietryga, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(21) Appl. No.: 11/514,520

(22) Filed: Aug. 31, 2006

(51) Int. Cl. C09K 11/77; B32B 1/00; C09K 11/08

(52) U.S. Cl. 428/403; 252/301.4 S; 252/301.4 R; 977/824; 977/834

(57) ABSTRACT

The present invention is directed to surface-modified lead chalcogenide nanocrystal quantum dots that are a reaction product of lead chalcogenide nanocrystal quantum dots and a metal such as a cadmium compound.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates to lead chalcogenide nanocrystal quantum dots such as lead selenide, lead sulfide or lead telluride, and more particularly to surface-treated lead chalcogenide nanocrystal quantum dots. The present invention further relates to processes of forming such surface-treated lead chalcogenide nanocrystal quantum dots. Additionally, the present invention relates to surface-treated lead chalcogenide nanocrystal quantum dots having enhanced stability and to processes of forming such surface-treated lead chalcogenide nanocrystal quantum dots with enhanced stability and optical properties.

### BACKGROUND OF THE INVENTION

Semiconductor nanocrystals (NCs), often referred to as nanocrystal quantum dots (NQDs), are of interest for their size tunable optical and electronic properties. Intermediate between the discrete nature of molecular clusters and the collective behavior of the bulk material, NQDs are unique building blocks for the bottom-up assembly of complex functional structures. NQDs can be conveniently synthesized using colloidal chemical routes such as solution based organometallic synthesis approaches for the preparation of CdSe NQDs described by Murray et al., J. Am. Chem. Soc., 115, 8706 (1993) or by Peng et al., J. Am. Chem. Soc., 123, 183 (2001), such references incorporated herein by reference. Generally, these procedures involve an organometallic approach. Typically, these chemical routes yield highly crystalline, monodisperse samples of NQDs. Due to their small dimensions and chemical flexibility, colloidal NQDs can be viewed as tunable “artificial” atoms and as such can be manipulated into larger assemblies engineered for specific applications.

Among the class of semiconductor materials referred to as lead chalcogenides, one material of interest is lead selenide, which has a bulk band gap of 0.26 electron volts (eV) corresponding to emission of about 4.7 μm and has a large exciton size (a Bohr radius of 46 nm).

A colloidal preparative process for small nanocrystal quantum dots emitting in the near-infrared region is known (Murray et al., IBM J. Res. Dev., 45, 47 (2001) and Guyot-Sionnest et al., J. Phys. Chem. B, 106, 10634 (2002)). Amplified spontaneous emission has been observed from 1425 to 1625 nm in PbSe films and for PbSe-titania nanocomposites (Schaller et al., J. Phys. Chem. B, 107, 13765 (2003)). Still further, colloidal lead selenide nanocrystal quantum dots have been prepared for mid-infrared emission (Pietryga et al., J. Am. Chem. Soc., 126, 11752 (2004). Various size-specific syntheses of colloidal lead selenide nanocrystal quantum dots have also been reported with room temperature emission over the range of about 1 μm to about 3.5 μm (corresponding to nanocrystal quantum dot diameters of about 2 to 17 nm). Among shortcomings present in these colloidal lead selenide nanocrystal quantum dots are included poor stability upon exposure to ambient conditions (air, room temperature (20° C.), and either artificial room light or natural sunlight). Studies using synchrotron XPS have suggested that selenium upon the surface of such lead selenide quantum dots is prone to oxidation, especially in larger, less thoroughly passivated and less brightly emitting mid-IR nanocrystal quantum dots (Supra, et al., J. Phys. Chem B, 110, 15244 (2006)). Protection from ambient conditions (e.g., storage is a dark, cold, inert atmosphere) is typically required to engender stability in optical and chemical properties beyond 24 hours. Surface modification as described herein can provide stability in optical properties. In addition; surface modification of the lead chalcogenide nanocrystal quantum dots provides for considerable tunability of the material's optical properties, where absorption and emission wavelength can be controllably shifted by the process described herein. Further, this process can lead to increased emission intensity and greater chemical flexibility for enhanced processibility.

### SUMMARY OF THE INVENTION

In accordance with the purposes of the present invention, as embodied and broadly described herein, the present invention provides surface-modified lead chalcogenide nanocrystal quantum dots including a reaction product of lead chalcogenide nanocrystal quantum dots from a non-aqueous process and a cadmium precursor, cadmium precursor solution or a cadmium precursor suspension, where resultant cadmium-surface-modified lead chalcogenide nanocrystal quantum dots are characterized as having significantly increased stability in optical properties over time upon exposure to conditions selected from the group consisting of air, light, ambient or higher temperatures, and combinations thereof in comparison to unmodified lead chalcogenide nanocrystal quantum dots exposed to the same conditions. Additional benefits provided by this surface treatment include enhanced optical and chemical properties.

The present invention still further provides a process for preparing surface-treated lead chalcogenide quantum dots comprising admixing lead chalcogenide nanocrystal quantum dots with a cadmium-containing solution for a period of time sufficient to form said cadmium-enhanced lead chalcogenide nanocrystal quantum dots.

The present invention still further may provide for the stable, off-the-shelf absoption and emission properties, whereby the absorption and emission characteristics of the surface-treated lead chalcogenide quantum dot will not spectrally shift upon storage, in use (assuming end-use implies near-ambient conditions), or upon incorporation into a matrix material (e.g., sol-gel or polymer). The process, therefore, may allow the use of surface-treated lead chalcogenide nanocrystal quantum dots in such applications as currency and security markers, biological tags for infrared imaging, infrared photodetectors, photovoltaic devices, and various optical tags, where stability in optical properties is critical for performance.

### BRIEF DESCRIPTION OF THE DRAWINGS

FIG. 1 shows photoluminescence (emission) peak position over time for conventional, untreated PbSe nanocrystal quantum dots (i.e., dots prepared in the process of Murray et al.). Significant blue-shifting was observed for nanocrystals stored in ambient conditions (air, room temperature, room light). In contrast, little or no blue-shifting was observed for Cd-treated PbSe nanocrystals of the present invention stored under even ambient conditions.

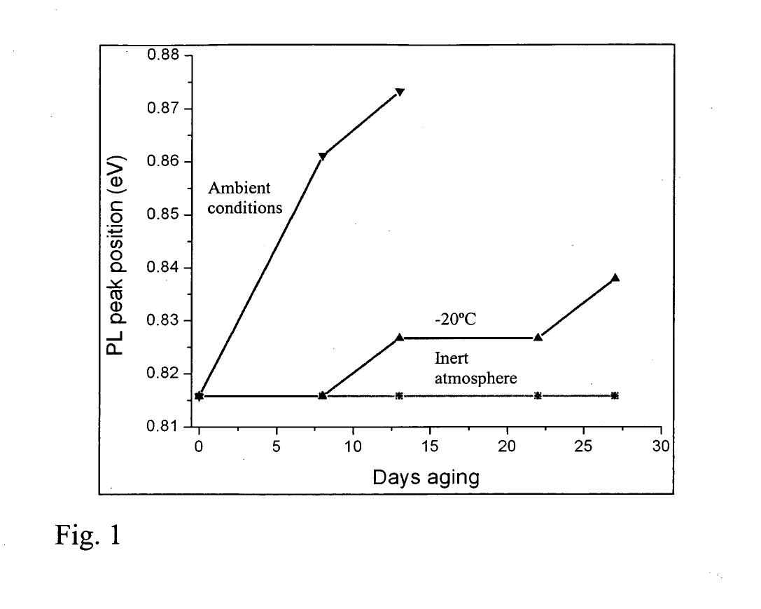

FIG. 2 shows plots of relative PL intensity versus days of aging. PL intensity is represented here as relative quantum yield. The same nanocrystals are shown both before and after cadmium treatment. The treatment resulted in significant enhancement of emission intensity, as well as enhanced stability in emission strength over time. The quantum yield of untreated PbSe NQDs at ambient temperatures was found to fall to zero in a matter of days.

FIG. 3 shows a plot of the photoluminescent (PL) intensity versus wavelength for various treatments with cadmium precursor with results demonstrating tunability and enhancement of emission intensity.

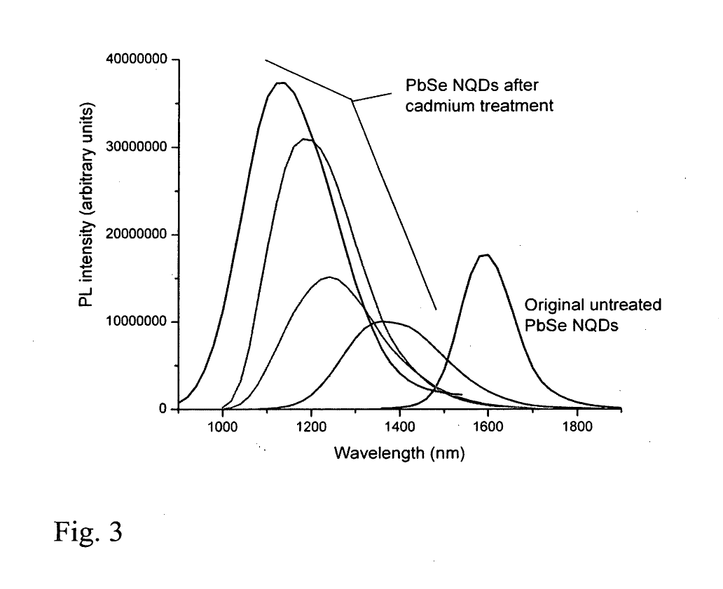

### DETAILED DESCRIPTION

The present invention is concerned with lead chalcogenide nanocrystal quantum dots and in particular surface-treated lead chalcogenide nanocrystal quantum dots, where the surface treated materials exhibit improved properties including, e.g., enhanced stability and optical properties (e.g., brighter emission).

As used herein, the terms “quantum dot”, nanocrystal” and “nanocrystal quantum dot” can be used interchangeably. All such terms refer to particles less than about 200 Angstroms in the largest axis, and preferably from about 10 to about 200 Angstroms. The nanocrystal quantum dots of the present invention are typically colloidal nanocrystal quantum dots, i.e., their preparation is a standard metal-organic colloidal method. Also, within particularly selected colloidal nanocrystal quantum dots, the colloidal nanocrystal quantum dots are generally substantially monodisperse, i.e., the particles have substantially identical size and shape.

The colloidal nanocrystal quantum dots are generally members of a crystalline population having a narrow size distribution. The shape of the colloidal nanocrystal quantum dots can be a sphere, a rod, a disk and the like. In one embodiment, the colloidal nanocrystal quantum dots include a core of a binary lead semiconductor material, e.g., a core of the formula MX, where M is lead and X is oxygen, sulfur, selenium or tellurium or mixtures thereof. In another embodiment, the nanocrystal quantum dots include a core of a ternary semiconductor material, e.g., a core of the formula M₁M₂X, where M₁ is lead, M₂ can be cadmium, zinc, mercury, aluminum, tin, gallium, indium, thallium, magnesium, calcium, strontium, barium, copper, and mixtures or alloys thereof and X is oxygen, sulfur, selenium, tellurium, or mixtures thereof. In still another embodiment, the colloidal nanocrystal quantum dots include a core of a quaternary semiconductor material, e.g., a core of the formula M₁M₂M₃X, where M₁ is lead, M₂ and M₃ can be cadmium, zinc, mercury, aluminum, tin, gallium, indium, thallium, magnesium, calcium, strontium, barium, copper, and mixtures or alloys thereof and X is oxygen, sulfur, selenium, tellurium, or mixtures thereof. Examples of the nanocrystal quantum dots include lead sulfide (PbS), lead selenide (PbSe), lead telluride (PbTe), and mixtures of such materials.

In other embodiments, the colloidal nanocrystal quantum dots may include a core of a metallic material such as gold (Au), silver (Ag), cobalt (Co), iron (Fe), nickel (Ni), copper (Cu), manganese (Mn), alloys thereof and alloy combinations with a shell of the surface-modified lead sulfide (PbS), lead selenide (PbSe), lead telluride (PbTe), and mixtures of such materials or the colloidal nanocrystal quantum dots may include a core of an organic or inorganic insulator material (e.g., a polymer, silica glass, sol-gel and the like) with a shell of the surface-modified lead sulfide (PbS), lead selenide (PbSe), lead telluride (PbTe), and mixtures of such materials. Other embodiments may include other heterostructures including the surface-modified lead chalcogenide nanocrystal quantum dots. Such heterostructures may retain or utilize the enhanced optical and/or chemical properties of the surface-modified lead chalcogenide nanocrystal quantum dots. Such heterostructures may include core/shell structures, or other types of heterostructures involving growth of a different material on the surface-modified lead chalcogenide nanocrystal quantum dots. Among the options may be included: conventional semiconductor/semiconductor “inorganic passivation” structures similar to the well-known CdSe/ZnSe system; reverse or type II structures where the shell has a band gap smaller than or similar to that of the core (i.e., the surface-modified lead chalcogenide nanocrystal quantum dots); semiconductor/metal structures where a semiconductor core is surrounded by a metal layer, either epitaxial or polycrystalline; semiconductor/insulator structures where a semiconductor core is surrounded by an organic or inorganic insulator material (e.g., a polymer, silica glass, sol-gel and the like). Heterostructures of the above combinations may also have an asymmetrical geometry, such as branched structures, dumbbells, or contact dimmers or oligomers. Generally, certain core-shell structures may be preferred where such a core-shell structure may be used to reduce the toxicity of the core material.

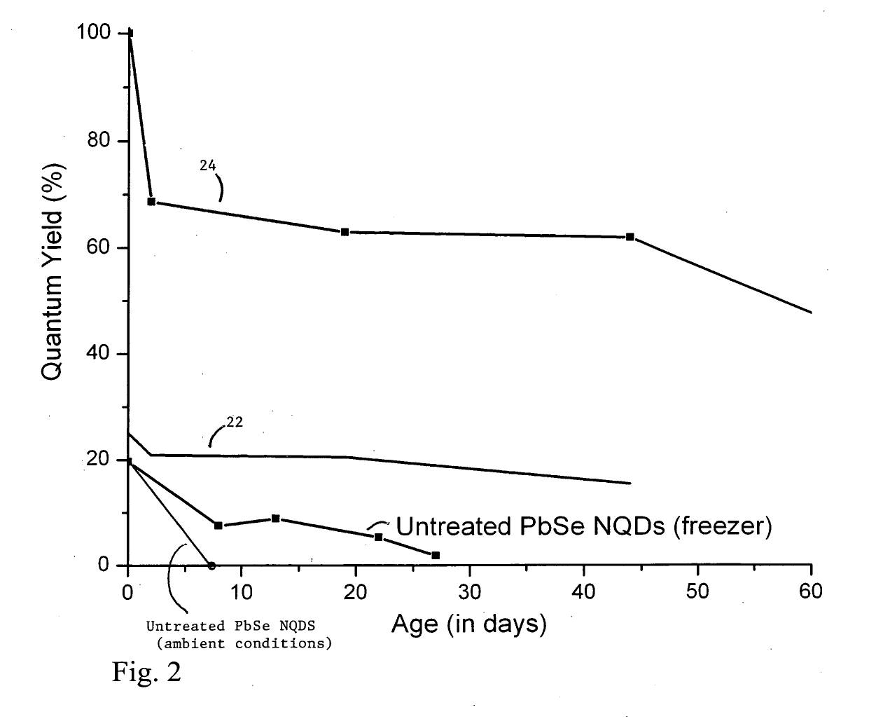

In the general process of the present invention, lead chalcogenide nanocrystal quantum dots can be admixed in solution at predetermined temperatures with a metal compound capable of reacting with the lead chalcogenide material to form a resultant product that differs from the lead chalcogenide nanocrystal quantum dot starting material. The resultant product is referred to as surface-treated lead chalcogenide nanocrystal quantum dots and the difference in properties can be dramatic and noticeable. One particular preferable metal for such a metal compound is cadmium. With cadmium as the metal reacted with the lead chalcogenide nanocrystal quantum dots several properties are clearly altered. First, the optical properties (absorption and emission spectra) of the product can be clearly blue-shifted, i.e., shifted to higher energies. Further and perhaps more critically, the stability in ambient conditions of the resultant product is significantly enhanced. Dots without the surface treatment have been typically found to have significantly poorer performance (see FIG. 2). Other metals may be used in place of the cadmium, e.g., metals such as zinc, mercury, tin, strontium and indium, but cadmium is preferred as the metal.

The temperature range for the admixture of the lead chalcogenide NQDs and the metal compound, e.g., cadmium compound, is typically from about 10° C. to about 250° C., more preferably from about 20° C. to about 150° C., most preferably from about 20° C. to about 100° C. Such temperatures are selected at levels insufficient to damage the core lead chalcogenide material. Lower temperatures generally result in less blue shift in the resultant product and control of the temperature can be one manner of adjusting the blue shift.

The admixture is generally maintained at the desired temperatures for a period of time from about 1 minute to about 48 hours, more preferably from about 2 hours to about 18 hours.

The admixture is generally carried out in a non-coordinating solvent, generally a non-polar solvent of, e.g., toluene, phenyl ether, decene, octadecene and the like. Generally, the solvent should have boiling point higher than the temperature whereat the reaction is conducted.

The cadmium compound can generally be any cadmium compound that is generally soluble or suspendable in the selected solvent, and is generally selected from among compounds including dimethyl cadmium, cadmium oxide, cadmium oleate, cadmium stearate and cadmium carboxylates. One preferred cadmium compound is cadmium oleate (typically prepared from cadmium oxide).

In general, the surface-treated lead chalcogenide nanocrystal quantum dots of the present invention can be a lead selenide, a lead sulfide or a lead telluride. Surface-treated lead selenide nanocrystal quantum dots are preferred for some applications.

In one embodiment of the present invention, a surface-treated lead chalcogenide nanocrystal quantum dots has been treated with cadmium. It has been demonstrated that such a cadmium-surface treated lead selenide exhibits an enhancement in stability relative to untreated lead selenide nanocrystal quantum dots. This procedure can be extended to the other lead chalcogenide materials such as lead sulfide and enhanced stability in such lead chalcogenides can allow for fabrication into devices and use in applications requiring near-to-mid infrared wavelengths in absorption and/or emission (e.g., 800 nm to 4000 nm).

In a further embodiment of the present invention, colloidal surface-treated lead chalcogenide nanocrystal quantum dots can be mixed with a lower alcohol, a non-polar solvent and a sol-gel precursor material and the resultant solution can be used to form a solid composite. For example, the solution can be deposited onto a suitable substrate to yield homogeneous, solid composites from the solution of colloidal surface-treated lead chalcogenide nanocrystal quantum dots and sol-gel precursor. By homogeneous, it is meant that the colloidal surface-treated lead chalcogenide nanocrystal quantum dots are uniformly dispersed in the resultant product. In some instances, non-uniform dispersal of the colloidal surface-treated lead chalcogenide nanocrystal quantum dots is acceptable. In some embodiments of the invention, the solid composites can be transparent or optically clear. This is a simple straightforward process for preparing such solid composites.

The lower alcohol used in this process is generally an alcohol containing from one to four carbon atoms, i.e., a C₁ to C₄ alcohol. Among the suitable alcohols are included methanol, ethanol, n-propanol, isopropanol, n-butanol, sec-butanol and t-butanol. The non-polar solvent is as described previously. Suitable sol-gel materials are well known to those skilled in the art.

In one further embodiment of the present invention, the surface-treated lead chalcogenide nanocrystal quantum dots may be incorporated into a polymer matrix, where the nanoparticle-matrix composite is prepared by co-dissolution of nanoparticles and polymer (e.g., polystyrene) in a co-solvent (e.g., chloroform) followed by evaporation of the co-solvent. Alternatively, nanoparticles can be dissolved in an appropriate monomer, and to this mixture can be added crosslinker(s) and heat or light stimulated initiators to promote polymerization and incorporation of the nanoparticles into the polymer matrix.

For the processes of the present invention, the colloidal nanocrystal quantum dots can include semiconductor NQDs such as lead sulfide (PbS), lead selenide (PbSe), lead telluride (PbTe), and mixtures of such materials.

In one embodiment of the process of the present invention, a method for preparing the surface-modified lead chalcogenide nanocrystal quantum dots can involve solution inorganic/organometallic/metal-organic/colloidal chemistry, although other routes may be used as well.

The present invention is more particularly described in the following examples that are intended as illustrative only, since numerous modifications and variations will be apparent to those skilled in the art.

### EXAMPLE 1

Lead selenide nanocrystals were initially prepared via standard colloidal methods as previously described by Murray et al., IBM J. Res. & Dev. 2001, 45, 47 with either lead oxide or lead acetate, oleic acid and trioctylphosphine selenium (TOPSe) in a high boiling, non-coordinating organic solvent. 32 milligrams (mg) of the lead selenide nanocrystals were twice precipitated from a hexane solution by addition of methanol and acetone to remove excess ligands and precursors, then dispersed in 10 milliliters (ml) of toluene under an inert atmosphere of nitrogen or argon. A solution of cadmium oleate was prepared by heating 140 mg of cadmium oxide (CdO) and 1.0 ml of oleic acid in 3.2 ml of phenyl ether to 255° C. under nitrogen until clear, and then allowed to cool to 100° C. under a flow of nitrogen to remove water formed during the reaction. The lead selenide nanocrystal solution was then heated to 100° C., and the cadmium oleate solution was added to the lead selenide nanocrystals. The admixture was allowed to stir under nitrogen at 100° C. for 20 hours, during which time small aliquots were removed by syringe to track the progress of the reaction. The admixture was then quenched by addition of cold (−20° C.) hexane with mixing. Excess reactants were removed by precipitation of the nanocrystals by addition of methanol. The supernatant was discarded and the nanocrystals redispersed in a non-polar solvent of hexane. Toluene and chloroform, for example, can be used in place of the hexane.

Analysis of the resultant nanocrystals demonstrated markedly noticeable changes in absorbance and emission spectra from the lead selenide nanocrystals as modified by the addition of cadmium. These changes can be used to verify the outcome of the synthesis. The original lead selenide nanocrystals had an emission peak at 1600 nm and a measured efficiency (quantum yield) of 28%. As the reaction with the cadmium progressed, the emission was progressively shifted to shorter wavelengths, and emission efficiency increased, as monitored by spectroscopy performed on the aliquots. Eventually, after 20 hours, the emission peak was at 1150 nm and the measured efficiency (quantum yield) was 82%.

Although the cadmium-enhanced lead selenide nanocrystal quantum dots from the reaction exhibited increased emission efficiency, the most notable change in properties was an increased stability in ambient and even harsher conditions. As conventionally synthesized, lead chalcogenide nanocrystals such as lead selenide are among the best infrared fluorophores available, but they are unstable upon exposure to air, light, and/or ambient temperatures. Normally the emission of these nanocrystals undergoes dramatic shifts to shorter wavelengths within 24 hours even under ambient conditions and emission efficiency falls to almost zero sometimes in a matter of only a few days. Even storage under an inert atmosphere, storage in the dark, and storage at reduced temperatures only prolongs the shelf life to (a few) weeks at best. The metal enhanced (e.g., cadmium) nanocrystal quantum dots of the present invention have maintained emission efficiencies well in excess of ordinary lead chalcogenide quantum dots for several months, even when stored in air at room temperature. Further, significantly, the metal enhanced nanocrystal quantum dots of the present invention have exhibited no peak shifting.

The enhanced stability has also been demonstrated under even harsher chemical conditions. Quantum dots of various compositions have been cast into polymer shapes and films under a variety of ways. One popular and successful way involves dispersing quantum dots into a liquid monomer, adding a cross-linker and an initiator, and heating to polymerize the mixture. In many materials, the resultant solids maintain much of the emission efficiency of the quantum dots. Although this is true for lead chalcogenide (e.g., selenide) quantum dots when initially formed into a polymer matrix, small amounts of unreacted initiator typically remain in the polymer and react with the quantum dots to substantially diminish the emission within a few days. The cadmium-modified lead chalcogenide nanocrystal quantum dots dispersed within these types of polymer systems have maintained their emission without a decline or peak shifting over several months.

### EXAMPLE 2

Another run was conducted in accordance with example 1 where for this reaction, 14 mg of PbSe dots and 70 mg of CdO were used, and the treatment was carried out at a temperature of 110° C.

FIG. 2 shows plots of relative PL intensity represented as relative quantum yield. The plot of line 22 is for a lightly cadmium-treated NQD under ambient conditions and was an early aliquot of the reaction while the plot of line 24 is for a heavily cadmium-treated NQD under ambient conditions and was an aliquot of the reaction taken after 20 hours. Further, the “untreated” dots had an emission peak at 1600 nm (0.78 eV), the lightly treated were at 1380 nm (0.90 eV), and the heavily treated were at 1150 nm (1.1 eV).

Although the present invention has been described with reference to specific details, it is not intended that such details should be regarded as limitations upon the scope of the invention, except as and to the extent that they are included in the accompanying claims.

What is claimed is:

1. Surface-modified lead chalcogenide nanocrystal quantum dots comprising:
a reaction product of: (i) lead chalcogenide nanocrystal quantum dots from a non-aqueous process; and (ii) a cadmium precursor, cadmium precursor solution, or cadmium precursor suspension, where resultant cadmium-surface-modified lead chalcogenide nanocrystal quantum dots are characterized as having increased stability in optical properties over time upon exposure to conditions selected from the group consisting of air, light, ambient or higher temperatures, and combinations thereof in comparison to unmodified lead chalcogenide nanocrystal quantum dots exposed to the same conditions.

2. The surface-modified lead chalcogenide nanocrystal quantum dot of claim 1 wherein the resultant cadmium-surface-modified lead chalcogenide nanocrystal quantum dots are characterized as having increased emission intensity in comparison to unmodified lead chalcogenide nanocrystal quantum dots.

3. The surface-modified lead chalcogenide nanocrystal quantum dot of claim 1 wherein the resultant cadmium-surface-modified lead chalcogenide nanocrystal quantum dots are characterized as having enhanced chemical processibility into inorganic, organic and/or sol-gel matrices in comparison to unmodified lead chalcogenide nanocrystal quantum dots.

4. The surface-modified lead chalcogenide nanocrystal quantum dot of claim 2 wherein the resultant cadmium-surface-modified lead chalcogenide nanocrystal quantum dots are characterized as having enhanced chemical processibility into inorganic, organic and/or sol-gel matrices in comparison to unmodified lead chalcogenide nanocrystal quantum dots.

5. The surface-modified lead chalcogenide nanocrystal quantum dot of claim 1 wherein lead chalcogenide is selected from the group consisting of lead selenide, lead sulfide, lead telluride, mixtures thereof, or alloys thereof, or oxides thereof.

6. The surface-modified lead chalcogenide nanocrystal quantum dot of claim 1 wherein said lead chalcogenide is lead selenide.

7. The surface-modified lead chalcogenide nanocrystal quantum dot of claim 1 wherein said lead chalcogenide is lead sulfide.

8. The surface-modified lead chalcogenide nanocrystal quantum dot of claim 1 wherein said lead chalcogenide is lead telluride.

9. The surface-modified lead chalcogenide nanocrystal quantum dot of claim 2 wherein said lead chalcogenide is an alloy of a formula selected from the group consisting of PbSeₓS₁₋ₓ, PbSeₓTe₁₋ₓ, PbTeₓS₁₋ₓ, and PbSe_{1-x-y}SₓTe_{y}, or oxides thereof.

10. A process of enhancing stability of lead chalcogenide nanocrystal quantum dots comprising:
admixing lead chalcogenide nanocrystal quantum dots with a cadmium-containing solution or suspension at temperatures and for a period of time sufficient to form cadmium-enhanced lead chalcogenide nanocrystal quantum dots.

11. The process of claim 10 wherein the resultant cadmium-surface-modified lead chalcogenide nanocrystal quantum dots are characterized as having increased stability in optical properties over time upon exposure to conditions selected from the group consisting of air, light, ambient or higher temperatures, and combinations thereof in comparison to un-modified lead chalcogenide nanocrystal quantum dots.

12. The process of claim 10 wherein the resultant cadmium-surface-modified lead chalcogenide nanocrystal quantum dots are characterized as having increased emission intensity in comparison to un-modified lead chalcogenide nanocrystal quantum dots.

13. The process of claim 10 wherein the resultant cadmium-surface-modified lead chalcogenide nanocrystal quantum dots are characterized as having enhanced chemical processibility into inorganic, organic and/or sol-gel matrices in comparison to un-modified lead chalcogenide nanocrystal quantum dots.

14. The process of claim 11 wherein the resultant cadmium-surface-modified lead chalcogenide nanocrystal quantum dots are characterized as having increased emission intensity in comparison to un-modified lead chalcogenide nanocrystal quantum dots.

15. The process of claim 14 wherein the resultant cadmium-surface-modified lead chalcogenide nanocrystal quantum dots are characterized as having enhanced chemical processibility into inorganic, organic and/or sol-gel matrices in comparison to un-modified lead chalcogenide nanocrystal quantum dots.
